(19) United States
(12) Patent Application Publication
(10) Pub. No.: US 2006/0159012 A1
(43) Pub. Date: Jul. 20, 2006

(54) Method and system for managing messages with highly available data processing system

(76) Inventors: Hiroshi Yoshimoto, Yokohama (JP); Hiroya Tsuzuki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/316,990

(22) Filed: Dec. 27, 2005

(30) Foreign Application Priority Data
Dec. 28, 2004 (JP) 2004-382030

(51) Int. Cl. H04J 3/14; H04L 12/56

(52) U.S. Cl. 370/220; 370/412

(57) ABSTRACT

In a clustered message queuing system, when a fault occurs in an active system computer A, a standby system node refers to queue-node correspondence information stored in a disk device. By such processing, the standby system node recognizes the fact that queues having the same name as a queue used by the active system computer A are present in an active system computer B and an active system computer C. Then, the standby system node distributes messages remaining in the queue of the fault computer A to the active system computer B and the active system computer C. Processing of the messages distributed to these computers B and C is continued. Because the fault recovery processing permits one standby system node to perform fault recovery in a plurality of active system nodes, a computer system excellent in scalability can be provided.

### INCORPORATION BY REFERENCE

The present application claims priority from Japanese application JP2004-382030 filed on Dec. 28, 2004, the content of which is hereby incorporated by reference into this application.

### BACKGROUND OF THE INVENTION

The present invention relates to a message distribution technique in a clustered message queuing system.

In a message queuing system, even in the case where a transmitting side node and a receiving side node are not operating, a transmitting or receiving process can be carried out through queues independent of the operating state on the partner side if the node of the message queuing system is operating. Even in the case where communication failure or system down occurs, messages to be transmitted or received are never vanished because the messages are stored in a queue having a physical substance such as a disk device. Accordingly, it can be said that the message queuing system is highly reliable and excellent in extensibility and flexibility.

In a clustered message queuing system in which a disk device is shared among node apparatuses through a network, the node apparatuses can process one and the same application program in parallel and concurrently. Accordingly, transaction processes requested successively can be executed while load is balanced to the node apparatuses. This is a highly available system in which the operation of the system as a whole is never stopped even in the case where a fault occurs in any node apparatus.

Incidentally, the load balancing method in the message queuing system is roughly classified into two methods. One is a method of allocating queues to the node apparatuses. Such a technique has been disclosed in U.S. Pat. No. 6,711,606. The other is a method of sharing queues among the node apparatuses. Such a technique has been disclosed in U.S. Pat. No. 6,023,722.

In the clustered message queuing system, there may be used a method in which when a fault occurs in a certain node apparatus, a queue used by the fault node is taken over to another normal node apparatus to continue processing. Such a technique has been disclosed in JP-A-2004-32224.

### SUMMARY OF THE INVENTION

The method of allocating queues to the node apparatuses is more advantageous than the method of sharing queues among the node apparatuses because the former method has no queue access competition with respect to scalability.

The former method however has a problem in availability. The former method has a disadvantage in that messages remain when a fault occurs.

On the other hand, the method of sharing queues among the node apparatuses copes with the problem of availability because one and the same message is multicast to enable processing in another node apparatus when a fault occurs.

In the method of sharing queues among the node apparatuses, it is however known that network traffic increases.

If active system node apparatuses and a standby system node apparatus are constructed as clusters in accordance with the node apparatuses as in the method in which a queue used by a fault node is taken over to another normal node apparatus to continue processing, messages can be recovered without remaining messages at the time of occurrence of a fault but the cost for system construction and the cost for management of the standby system node apparatus increase.

In consideration of the foregoing problem in the background art, an object of the invention is to provide a message distribution method in a clustered message queuing system, a standby system node apparatus and a program to improve the problem concerned with availability at the time of occurrence of a fault while scalability is secured and to attain reduction in the cost for system construction and the cost for management of the standby system node apparatus.

To solve the problem, the invention provides a message distribution method in a clustered message queuing system including: active system node apparatuses for executing a user program; a standby system node apparatus for controlling distribution of messages remaining in queues used by the active system node apparatuses; and a storage device for storing queue-node correspondence information indicating correspondence between a queue used by each of the active system node apparatuses and a node apparatus using the queue, the storage device being connected to the active system node apparatuses and the standby system node apparatus; wherein the standby system node apparatus executes: a first step of acquiring a list of other active system node apparatuses using queues having the same name as a queue used by one of the active system node apparatuses by referring to the queue-node correspondence information stored in the storage device; and a second step of distributing remaining messages remaining in the queue used by one active system node apparatuses to queues used by active system node apparatuses contained in the list of other active system node apparatuses. The invention also provides a standby system node apparatus and a program for executing the aforementioned message distribution method.

That is, in the invention, when a fault occurs in a certain active system node apparatus, messages remaining in the queue used by the node apparatus can be distributed to queues used by other active system node apparatuses, so that processing of a user program concerned with the messages can be continuously executed by each node apparatus which is a message distribution destination. Accordingly, availability at the time of occurrence of a fault can be secured. Moreover, one standby system node apparatus can perform a message distribution process for fault recovery in active system node apparatuses in a clustered message queuing system including an arbitrary number of active system node apparatuses. That is, it can be said that scalability is secured while the cost for system construction and the cost for management of the standby system node apparatus are reduced.

In processing at the time of fault recovery in the clustered message queuing system, both availability and scalability can be secured while the cost for system construction and the cost for management of the standby system node apparatus can be reduced.

### BRIEF DESCRIPTION OF THE DRAWINGS

FIG. 1 is a diagram showing an example of a clustered message queuing system according to a first embodiment;

FIG. 2A is a view showing an example of the data structure of queue-node correspondence information;

FIG. 2B is a view showing an example of the data structure of queue sequence information;

FIG. 3 is a chart showing an example of a flow of fault recovery processing in the message queuing system;

FIG. 4 is a flow chart showing a specific procedure of a message takeover process;

FIG. 5 is a chart showing an example of a flow of fault recovery processing in the case where message processing is orderly in a clustered message queuing system according to a second embodiment;

FIG. 6 is a chart showing a specific procedure of a message takeover process in the case where message processing is orderly in the second embodiment;

FIG. 7 is a chart showing an example of a flow of fault recovery processing in consideration of load division into message distribution destination nodes in a clustered message queuing system according to a third embodiment;

FIG. 8 is a chart showing a specific procedure of a message takeover process in load division processing in the third embodiment;

FIG. 9 is a chart showing an example of a flow of scaling-out processing in a clustered message queuing system according to a fourth embodiment; and

FIG. 10 is a chart showing a specific procedure of a message takeover process in the scaling-out processing in the fourth embodiment.

### DESCRIPTION OF THE EMBODIMENTS

Embodiments of the invention will be described below in detail with reference to the drawings.

### First Embodiment

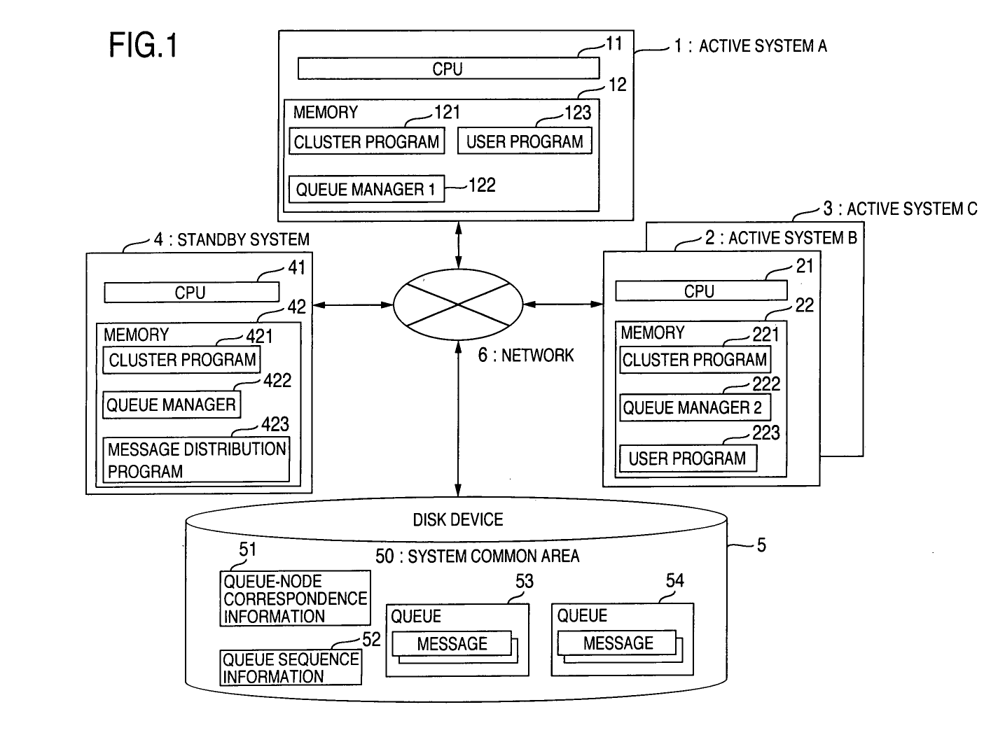

FIG. 1 is a diagram showing an example of a clustered message queuing system according to a first embodiment of the invention. As shown in FIG. 1, the clustered message queuing system is formed so that an active system A computer 1, an active system B computer 2, an active system C computer 3, a standby system computer 4 and a disk device 5 are connected to one another by a network 6.

These computers 1 to 4 form so-called node apparatuses in the network 6. In this specification and the drawings, these computers 1 to 4 are referred to as “nodes” simply. When # is A, B or C, an active system # computer is referred to as “active system #”. A standby system computer is referred to as “standby system”.

In FIG. 1, the active system A computer 1 includes a CPU (Central Processing Unit) 11, and a memory 12. A cluster program 121, a queue manager 122 and a user program 123 are stored in the memory 12. Incidentally, the memory 12 generally has a main memory portion made of a semiconductor memory, and an auxiliary memory portion made of a hard disk storage device.

The cluster program 121 communicates with a cluster program in the standby system computer 4 and has a function of monitoring occurrence of a fault, and a function of issuing a request to change the system at the time of occurrence of a fault. The queue manager 122 manages a queue to be used. The user program 123 registers messages in a queue operated through an API (Application Program Interface) and reads messages from the queue.

Incidentally, the “queue” is a logical queuing container for holding messages. The “queue” is generally provided as a file on the disk device 5. When a message is to be transmitted, the user program 123 designates a destination queue and issues a message registration API to thereby store the message in a transfer queue of a transmitting side node. As a result, the message stored in the transfer queue is taken out, for example, in accordance with FIFO (First-In First-Out) algorithm, transmitted to the predetermined destination queue and registered in the destination queue by a transfer function of the message queuing system.

Although only two queues 53 and 54 are shown in FIG. 1, the number of queues is larger than the number of active system computers because each active system computer uses at least one queue, usually a plurality of queues.

The user program 123 issues a message read API at the time of reception so that messages stored in the destination queue are taken out, for example, in the descending order of the length of storage time in the queue. Incidentally, a specific message may be taken out preferentially.

The active system B computer 2 includes a CPU 21, and a memory 22. A cluster program 221, a queue manager 222 and a user program 223 are stored in the memory 22. The respective functions of the cluster program 221, the queue manager 222 and the user program 223 are the same as those of the cluster program 121, the queue manager 122 and the user program 123 in the active system A computer 1.

The active system C computer 3 includes a CPU 31, and a memory 32. A cluster program 321, a queue manager 322 and a user program 323 are stored in the memory 32. The respective functions of the cluster program 321, the queue manager 322 and the user program 323 are the same as those of the cluster program 121, the queue manager 122 and the user program 123 in the active system A computer 1.

On the other hand, the standby system computer 4 includes a CPU 41, and a memory 42. A cluster program 421, a queue manager 422 and a message distribution program 423 are stored in the memory 42.

The message distribution program 423 acquires information of messages remaining in the queue used by a faulty node and selects nodes as destinations of distribution of the remaining messages on the basis of the remaining message information and queue-node correspondence information which will be described later. The remaining messages are distributed to the selected nodes and queue status information in the queue-node correspondence information is updated.

The respective functions of the cluster program 421 and the queue manager 422 are the same as those of the cluster program 121 and the queue manager 122 in the active system A computer 1.

In FIG. 1, the disk device 5 is used in common to the clustered nodes (the active system A computer 1, the active system B computer 2, the active system C computer 3 and the standby system computer 4) through the network 6. Areas of queue-node correspondence information 51 and queue sequence information 52 are allocated to a system common area 50. Areas of queues 53 and 54 are further allocated to the system common area 50 so that the areas of queues 53 and 54 correspond to the nodes respectively.

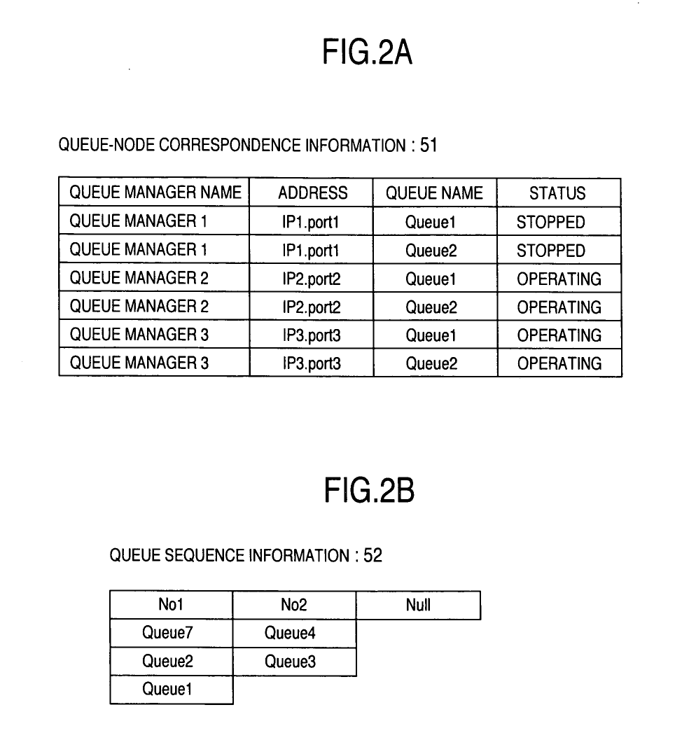

FIG. 2A is a view showing an example of the data structure of the queue-node correspondence information. FIG. 2B is a view showing an example of the data structure of the queue sequence information.

The queue-node correspondence information 51 is information for associating queues used by queue managers with the queue managers. As shown in FIG. 2A, the queue-node correspondence information 51 has fields of queue manager name, address, queue name and status. The “address” means a physical address indicating the place where a queue manager is stored. The “status” means a state indicating the operating condition of a queue. Incidentally, when remaining messages are taken over to another active system computer because of occurrence of a fault in the active system A computer 1, the operating state of the queue used by the queue manager 1 (122) of the active system A computer 1 is changed from “operating” to “stopped”.

The queue sequence information 52 is information defined by a user when message processing is orderly. For example, FIG. 2B shows the case where the sequence of messages in Queue1 needs to be warranted in Queue2 and Queue7 when messages in Queue1 are taken out and stored in Queue2 by the user program and messages in Queue2 are taken out and stored in Queue7 by the user program. Incidentally, in this case, messages need to be recovered in order of Queue7->Queue2->Queue1 so that the messages can be recovered while the sequence is kept.

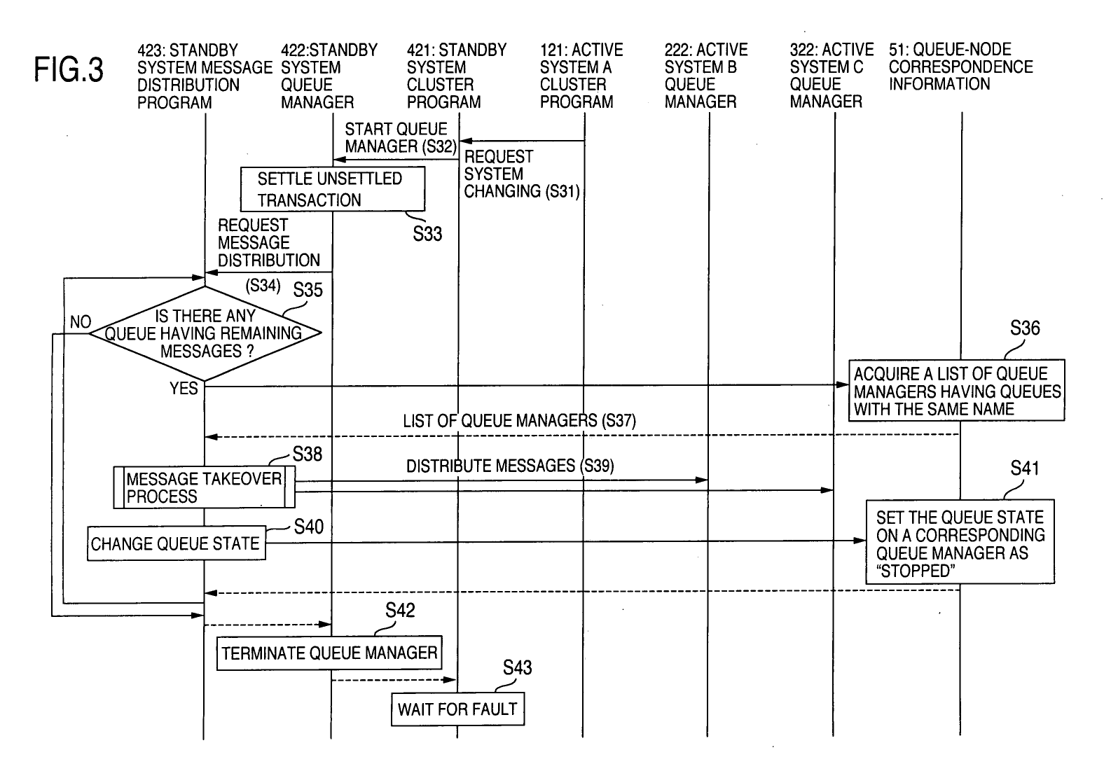

FIG. 3 is a chart showing an example of a flow of fault recovery processing in the message queuing system in this embodiment. That is, FIG. 3 shows an example of a process in which when a fault occurs in the active system A computer 1, messages remaining in the queue used by the active system A computer 1 are distributed to the queue managers of other active system computers (the active system B computer 2 and the active system C computer 3 in this embodiment) where no fault occurs. The contents of the process will be described below. Incidentally, “distribution of remaining messages to a queue manager” means distribution of remaining messages to a queue managed by the queue manager, that is, to a queue used by a computer (node) in which the queue manager is operating. In this specification, the same rule applies hereunder.

FIG. 3 shows respective operations of the message distribution program 423 of the standby system computer 4, the queue manager 422 of the standby system computer 4, the cluster program 421 of the standby system computer 4, the cluster program 121 of the active system A computer 1, the queue manager 222 of the active system B computer 2, the queue manager 322 of the active system C computer 3 and the queue-node correspondence information 51 in the system common area 50.

Generally, an exclusive communication line (not shown on FIG. 1) for notifying fault information is provided between the standby system computer 4 and each active system # computer 1, 2 or 3 (in which # is A, B or C), so that the standby system computer 4 can detect a fault in the active system # computer 1, 2 or 3 through the communication line. For example, assume that a fault occurs in the active system A computer 1. When the fault is detected by the cluster program 121, the cluster program 121 requests the cluster program 421 of the standby system computer 4 to change the system (step S31).

Upon reception of the request, the cluster program 421 of the standby system computer 4 operates the queue manager 422 (step S32). The queue manager 422 of the standby system computer 4 confirms the presence/absence of an unsettled (pending) transaction by referring to the queues 53 and 54 allocated to the active system A computer 1 where the fault occurs. When an unsettled transaction is present, the queue manager 422 executes a process for settling the unsettled transaction (step S33) and issues a message distribution request to the message distribution program 423 (step S34).

Upon reception of the message distribution request, the message distribution program 423 of the standby system computer 4 judges whether any queue having remaining messages is present in queues in the node (the active system A computer 1 in this embodiment) where the fault occurs (step S35). When the judgment results in the presence of any queue having remaining messages (Yes in step S35), the message distribution program 423 takes out one of the queues and acquires a list of queue managers having queues having the same name as the name of the queue by referring to the queue-node correspondence information 51 on the disk device 5 (steps S36 and S37).

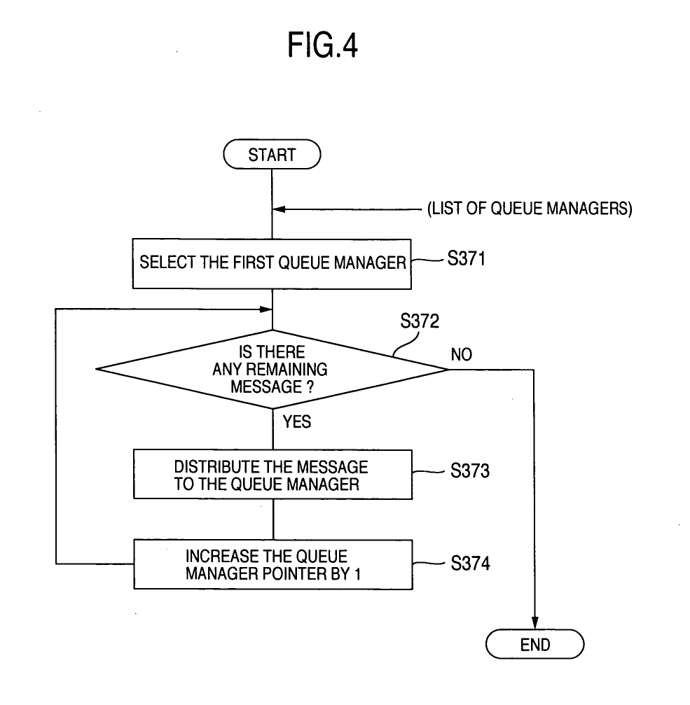

The message distribution program 423 then executes a message takeover process on the basis of the queue manager list to take over remaining messages to the other active system computers (step S38). A specific procedure of the message takeover process will be described below in detail with reference to FIG. 4.

FIG. 4 is a flow chart showing the specific procedure of the message takeover process. In FIG. 4, the message distribution program 423 selects the first queue manager by referring to the queue manager list (step S371). The message distribution program 423 checks whether any remaining message is present in the queue (step S372). When any remaining message is present (Yes in step S372), the message distribution program 423 takes out one of remaining messages and distributes the taken-out remaining message to the queue manager (step S373).

Then, the queue manager pointer is increased by one (step S374) to select a queue manager located next. The procedure of steps S372 to S374 is repeated until there is no remaining message (No in step S372). Incidentally, when the queue manager pointer reaches the last, the pointer is not increased but returned to the first in step S374.

Referring back to FIG. 3, when the message distribution program 423 distributes messages remaining in a queue in a fault node to other active system computers in the aforementioned manner (step S39), the message distribution program 423 changes the queue state of the queue (step S40). Specifically, the message distribution program 423 sets the queue state of the queue on the queue manager to “stopped” by referring to the queue-node correspondence information 51 in the system common area 50 (step S41).

Then, the situation of the process goes back to step S35. The procedure of steps S36 to S41 is repeated until there is no queue having remaining messages. When there is no queue having remaining messages (No in step S35), control is shifted to the queue manager 422 of the standby system computer 4. The queue manager 422 executes a termination process (step S42). The cluster program 421 goes to a fault standby state again (step S43), so that the fault recovery processing is terminated.

Although this embodiment has been described on the case where system change from the cluster program 121 of the fault active system A computer 1 to the cluster program 421 of the standby system computer 4 is requested (step S31), the procedure of steps S32 to S43 may be carried out when the cluster program 421 of the standby system computer 4 per se detects a fault in the active system A computer 1 through the exclusive line for notifying fault information even in the case where there is no request for system change.

As described above, in this embodiment, when a fault occurs in a certain node, the standby system node distributes messages remaining in a queue used by the fault node to faultless nodes so that processing of the remaining messages can be executed continuously in the distribution destination nodes. After the fault recovery processing is terminated, the standby system node goes to a fault standby state again. Therefore, in the message queuing system according to this embodiment, fault recovery in N active system nodes can be achieved by one standby system node when N is an arbitrary integer not smaller than 2. Accordingly, while scalability and availability can be secured, the cost for system construction can be reduced.

### Second Embodiment

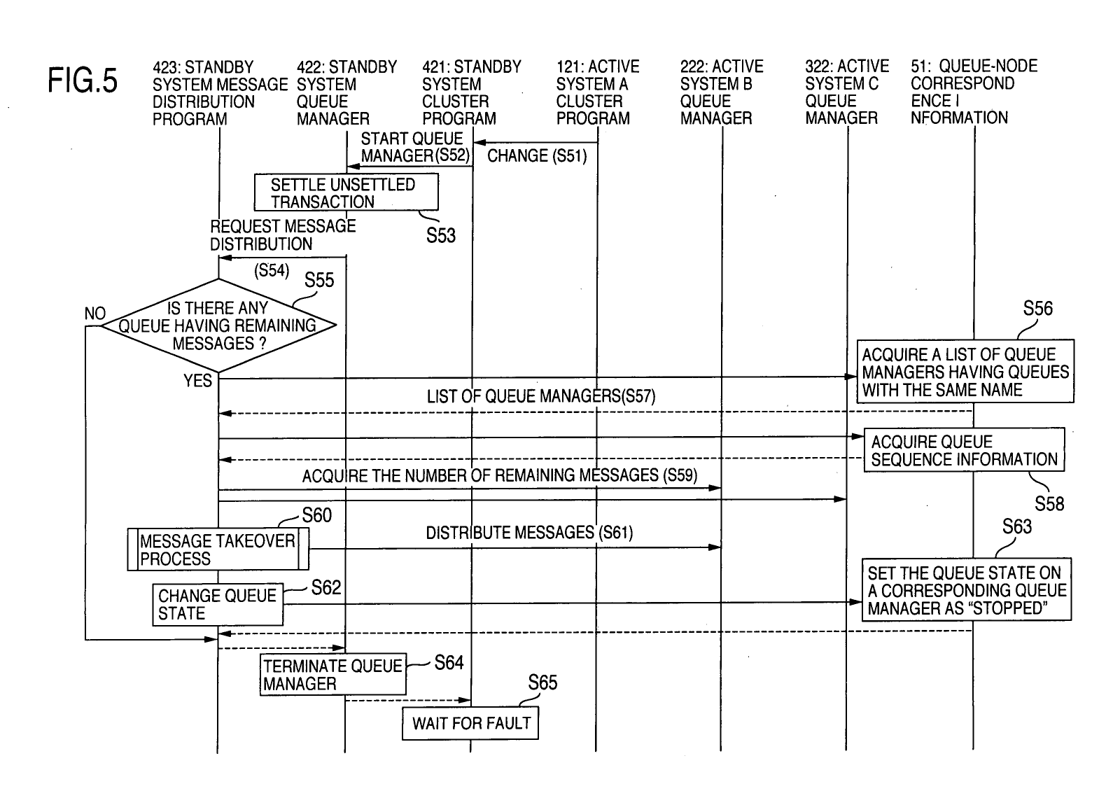

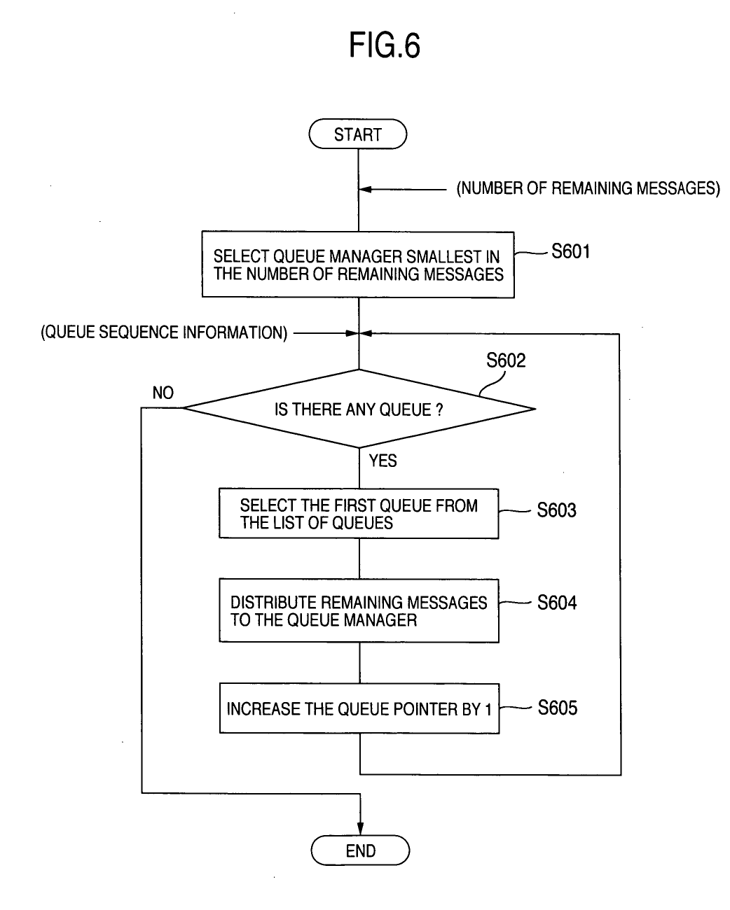

FIGS. 5 and 6 show, as a second embodiment, an example of the fault recovery processing in the case where message processing in the clustered message queuing system is orderly. FIG. 5 is a chart showing an example of a flow of fault recovery processing in the case where message processing in the clustered message queuing system is orderly. FIG. 6 is a flow chart showing a specific procedure of a message takeover process in the case where message processing is orderly.

That is, FIGS. 5 and 6 show an example of a process in which when a fault occurs in the active system A computer 1, messages remaining in a queue used by the active system A computer 1 are distributed to the queue manager of another active system computer (the active system B computer 2 in this embodiment) in accordance with a queue sequence based on the queue sequence information 52 stored in the disk device 51. The contents of the process will be described below. Incidentally, the configuration of the clustered message queuing system in this embodiment is substantially the same as the configuration of the first embodiment shown in FIGS. 1, 2A and 2B and the description thereof will be omitted. FIG. 5 will be described only with respect to a portion of difference from the fault recovery processing shown in FIG. 3.

The procedure of steps S51 to S57 in FIG. 5 is the same as the procedure of steps S31 to S37 in FIG. 3. Up to the step S57, the message distribution program 423 of the standby system computer 4 acquires a list of queue managers having queues with the same name as the queue used by the fault node from the queue-node correspondence information 51 on the disk device 5. The message distribution program 423 of the standby system computer 4 also acquires queue sequence information 52 an example of which is shown in FIG. 2B (step S58). The message distribution program 423 of the standby system computer 4 further acquires the numbers of remaining messages in the queue manager 222 of the active system B computer 2 and the queue manager 322 of the active system C computer 3 (step S59). Then, the message distribution program 423 selects a queue manager smallest in the number of remaining messages and executes a takeover process for distributing all messages to the queue manager (step S60). The detailed contents of the process in step S60 are shown in FIG. 6.

In FIG. 6, the message distribution program 423 of the standby system computer 4 selects a queue manager smallest in the number of remaining messages in accordance with the acquired number of remaining messages (step S601) and checks whether there is any queue based on the acquired queue sequence information (step S602). When there is any queue (Yes in step S602), the first queue is selected from the list of queues in the queue sequence information 52 (step S603). Then, the message distribution program 423 distributes messages remaining in the queue to the queue manager selected by the step S601 (step S604), the queue pointer (the pointer used instead of the first queue in step S603) is increased by one (step S605) and the situation of this routine goes back to step S602. The procedure of steps S603 to S605 is repeated till there remains no untreated queue with respect to the queues based in the queue sequence information (No in step S602).

Referring back to FIG. 5, the procedure (of steps S62 to S65) after the message distribution (step S61) is the same as the procedure (of steps S40 to S43) shown in FIG. 3. In this example, it is not necessary to return the situation of this routine to step S55 because remaining messages in all queues have been already distributed.

As described above, in accordance with the second embodiment, even in the case where messages are orderly, messages remaining in the queue used by the fault node can be distributed to a queue used by another faultless node at the time of occurrence of a fault, so that processing of the remaining messages can be continuously executed in the distribution destination node.

### Third Embodiment

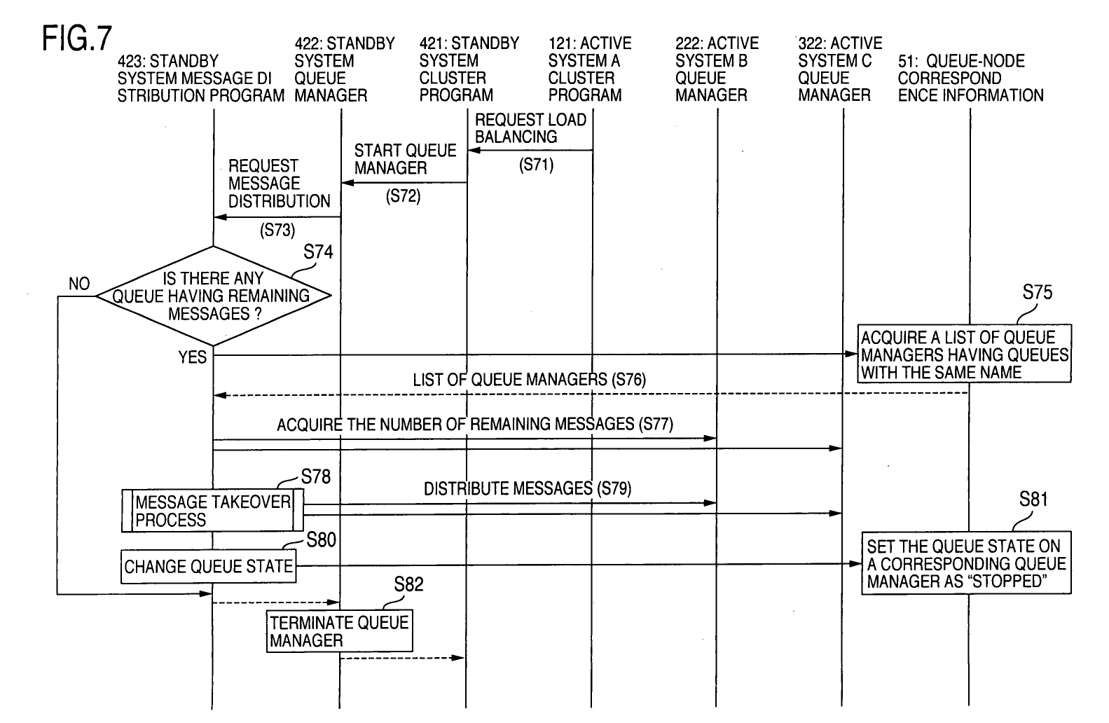

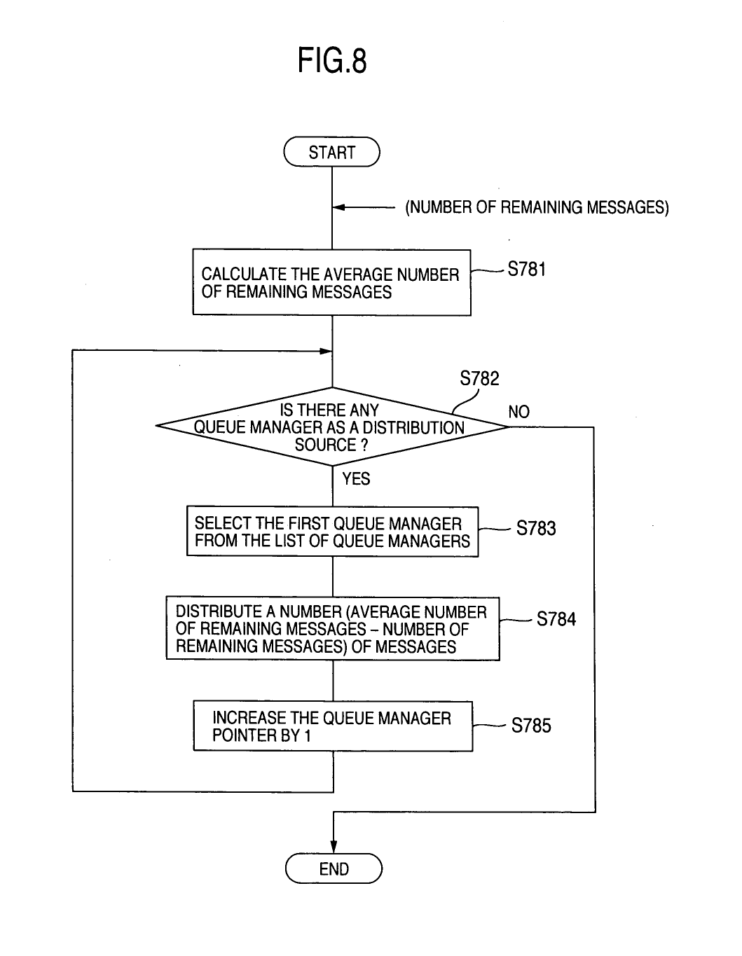

An example of the fault recovery processing in consideration of load division in message distribution destination nodes in a clustered message queuing system will be described as a third embodiment with reference to FIGS. 7 and 8. FIG. 7 is a chart showing an example of a flow of fault recovery processing in consideration of load division in message distribution destination nodes in a clustered message queuing system. FIG. 8 is a flow chart showing a specific procedure of a message takeover process in the load division process.

That is, FIGS. 7 and 8 show an example of a process in which messages remaining in the queue used by the active system A computer 1 at the time of occurrence of a fault in the active system A computer 1 are distributed to the queue managers of faultless active system computers (the active system B computer 2 and the active system C computer 3 in this embodiment) so that the numbers of messages remaining in queues used by the queue managers of the faultless active system computers are averaged. The contents of the process will be described below. Incidentally, the configuration of the clustered message queuing system in this embodiment is substantially the same as the configuration of the first embodiment shown in FIGS. 1, 2A and 2B and the description thereof will be omitted.

In FIG. 7, when, for example, a fault occurs in the active system A computer 1 and the fault is detected by the cluster program 121, the cluster program 121 requests the cluster program 421 of the standby system computer 4 to change the system and balance the load (step S71). As a result, the cluster program 421 of the standby system computer 4 operates the queue manager 422 of the standby system computer 4 (step S72). The queue manager 422 requests the message distribution program 423 of the standby system computer 4 to distribute messages (step S73).

The processing in the message distribution program 423 is substantially the same as that shown in FIG. 3 but a process (step S77) of acquiring the number of remaining messages from queue managers 222 and 322 of other active systems B and C is added to the processing shown in FIG. 3 because of the necessity of mean division of the load. A message takeover process is performed in accordance with the acquired numbers of remaining messages so that loads on the active system computers 1, 2 and 3 are balanced (step S78). The detailed contents of the processing in step S78 are shown in FIG. 8.

In FIG. 8, the message distribution program 423 of the standby system computer 4 first calculates the average number of remaining messages in the active system computers, inclusive of the active system having issued the load division request, on the basis of the acquired numbers of remaining messages (step S781). Then, the message distribution program 423 checks whether there is any queue manager as a distribution source in the list of queue managers (step S782). When there is any queue manager as a distribution source (Yes in step S782), the message distribution program 423 selects the first queue manager from the list of queue managers (step S783). Then, the message distribution program 423 regards messages of the number obtained by subtracting the number of remaining messages from the calculated average number of remaining messages as takeover messages and distributes the takeover messages to the selected queue manager (step S784). Then, the queue manager pointer (indicating the position to be substituted for the first queue manager in the list of queue managers in step S783) is increased by one (step S785) and the situation of this routine goes back to step S782. When there remains no queue manager as a distribution source in the list of queue managers (No in step S782), the process is terminated.

As described above, in accordance with the third embodiment, messages remaining in the queue used by the fault active system node at the time of occurrence of a fault can be dispersively distributed so that the numbers of messages remaining in queues used by distribution destination active system nodes are averaged.

### Fourth Embodiment

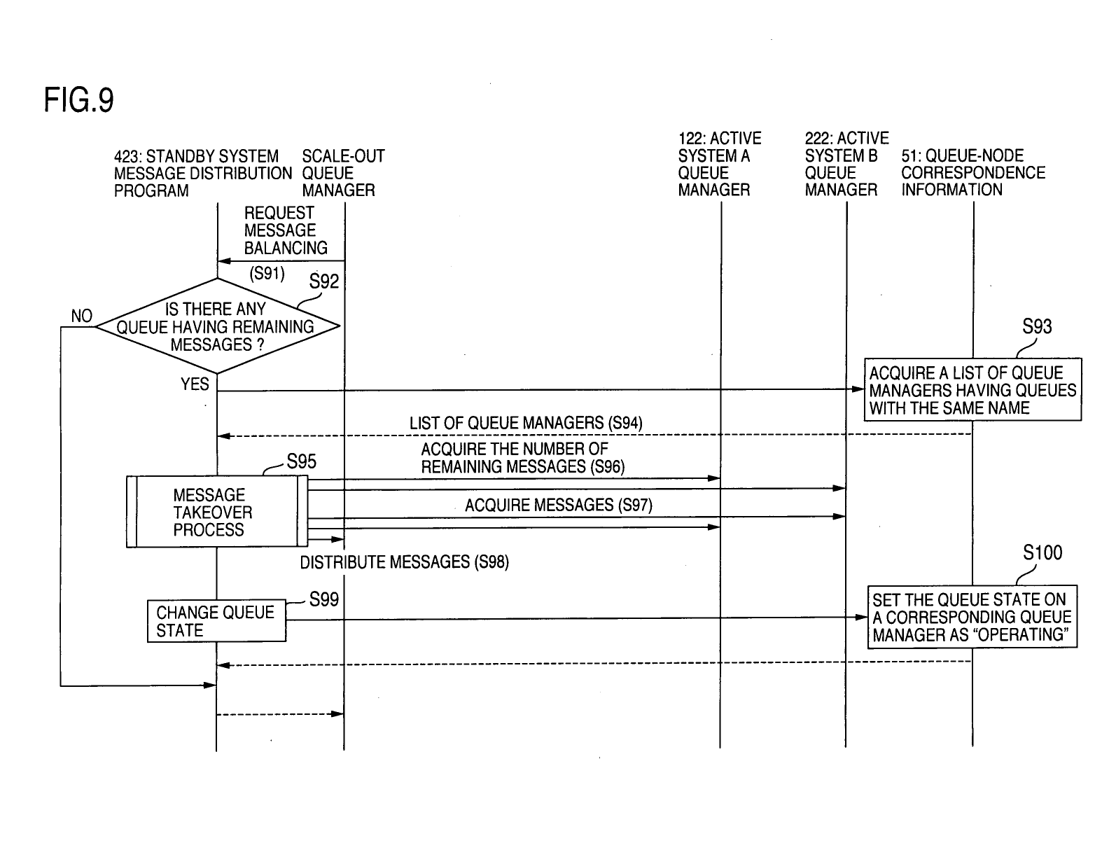

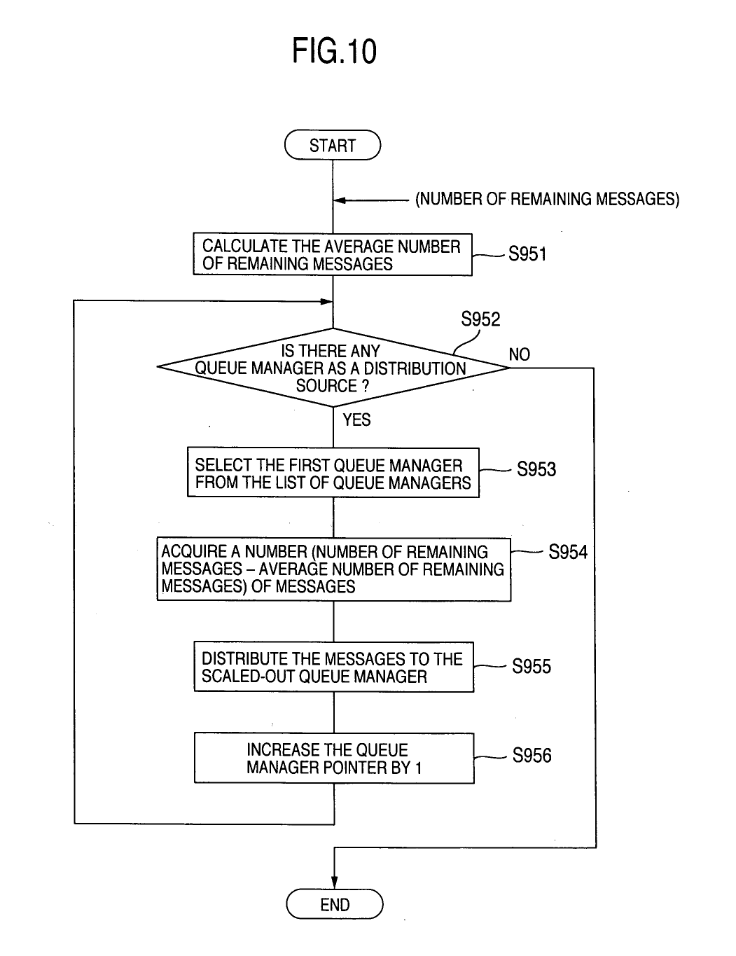

An example of scale-out processing for adding a new node to the clustered message queuing system will be described as a fourth embodiment with reference to FIGS. 9 and 10. FIG. 9 is a chart showing an example of a flow of scale-out processing in the clustered message queuing system. FIG. 10 is a flow chart showing details of a message takeover process in the scale-out processing.

FIGS. 9 and 10 show an example of a process in which messages remaining in queues used by queue managers of operating computers (the active system A computer 1 and the active system B computer 2 in this embodiment) are distributed to a queue manager of a scaled-out computer when a new computer is added (scaled out) to the message queuing system being in operation. The contents of this process will be described below. Incidentally, the configuration of the clustered message queuing system in this embodiment is substantially the same as the configuration of the first embodiment shown in FIGS. 1, 2A and 2B and the description thereof will be omitted.

In the scale-out processing, messages remaining in the active system nodes are distributed to a node added by scaling-out. As shown in FIG. 9, the queue manager of the scale-out node first requests the message distribution program 423 of the standby system computer 4 to balance messages (step S91). The message distribution program 423 performs the same process as that shown in FIG. 3 except the message takeover process (step S95) as shown in FIG. 10. Incidentally, for execution of the message takeover process, the message distribution program 423 acquires the numbers of remaining messages from the queue managers 122 and 222 of the active system computers (step S96).

In FIG. 10, the message distribution program 423 of the standby system computer 4 calculates the average number of remaining messages, inclusive of the node to be added, on the basis of the acquired numbers of remaining messages (step S951). Then, the message distribution program 423 checks whether there is any queue manager as a distribution source in the list of queue managers (step S952). When there is any queue manager as a distribution source (Yes in step S952), the message distribution program 423 selects the first queue manager from the list of queue managers (step S953). Then, the message distribution program 423 acquires messages of the number obtained by subtracting the average number of remaining messages calculated by the step S951 from the number of remaining messages acquired by the step S96 from the selected queue manager (step S954). The acquired messages are distributed to the scaled-out queue manager (step S955). Then, the queue manager pointer (indicating the position to be substituted for the first queue manager in the list of queue managers in step S953) is increased by one (step S956) and the situation of this routine goes back to step S952. When there remains no distribution source queue manager in the list of queue managers (No in step S952), the process is terminated.

Incidentally, in FIG. 9, the message distribution program 423 changes the queue state (step S99) after the message distribution (step S98). Specifically, the message distribution program 423 sets the queue state on the scaled-out queue manager as “operating” by referring to the queue-node correspondence information 51 in the system common area 50 (step S100).

As described above, in accordance with the fourth embodiment, also when a scaled-out node is added newly, part of messages remaining in queues used by active system nodes can be taken out so that the numbers of remaining messages in respective queues are averaged, and the taken-out messages can be distributed to a queue used by the newly added node.

It should be further understood by those skilled in the art that although the foregoing description has been made on embodiments of the invention, the invention is not limited thereto and various changes and modifications may be made without departing from the spirit of the invention and the scope of the appended claims.

1. A message distribution method in a clustered computer system including:
active system node apparatuses for storing accepted messages in queues respectively and executing a user program on the basis of the accepted messages;
a standby system node apparatus; and
a storage device for storing queues used by the active system node apparatuses respectively, the storage device being formed so that the active system node apparatuses and the standby system node apparatus can make access to the storage device;
wherein when occurrence of a fault in any one of the active system node apparatuses is recognized, the standby system node apparatus distributes remaining messages remaining in a queue used by the fault active system node apparatus to a queue used by another active system node apparatus having no fault.

2. A message distribution method in a clustered computer system including:
active system node apparatuses for storing accepted messages in queues respectively and executing a user program on the basis of the accepted messages;
a standby system node apparatus; and
a storage device for storing queue-node correspondence information indicating correspondence between a queue used by each of the active system node apparatuses and a node apparatus using the queue, the storage device being formed so that the active system node apparatuses and the standby system node apparatus can make access to the storage device;
wherein when occurrence of a fault in any one of the active system node apparatuses is recognized, the standby system node apparatus executes:
a first step of acquiring a list of other active system node apparatuses using queues having the same name as a queue used by one of the active system node apparatuses by referring to the queue-node correspondence information stored in the storage device; and
a second step of distributing remaining messages remaining in the queue used by one active system node apparatus to queues used by active system node apparatuses contained in the list of other active system node apparatuses.

3. A message distribution method according to claim 2, wherein:
the standby system node apparatus acquires the numbers of remaining messages by referring to queues used by active system node apparatuses contained in the list of other active system node apparatuses after execution of the first step; and
the standby system node apparatus distributes the remaining messages at the second step so that the numbers of remaining messages in queues used by active system node apparatuses contained in the list of other active system node apparatuses are averaged on the basis of the acquired numbers of remaining messages.

4. A message distribution method according to claim 2, wherein:
the standby system node apparatus acquires queue sequence information stored in the storage device and indicating a message processing sequence after execution of the first step; and
the standby system node apparatus distributes the remaining messages to a queue used by one of active system node apparatuses contained in the list of other active system node apparatuses in a sequence based on the acquired queue sequence information at the second step.

5. A message distribution method in a clustered computer system including:
active system node apparatuses for storing accepted messages in queues respectively and executing a user program on the basis of the accepted messages;
a standby system node apparatus; and
a storage device for storing queue-node correspondence information indicating correspondence between a queue used by each of the active system node apparatuses and a node apparatus using the queue, the storage device being formed so that the active system node apparatuses and the standby system node apparatus can make access to the storage device;
wherein when the standby system node apparatus receives a message distribution request from an active system node apparatus added to the message queuing system, the standby system node apparatus executes:
a first step of acquiring a list of other active system node apparatuses using queues having the same name as a queue used by the added active system node apparatus by referring to the queue-node correspondence information stored in the storage device; and
a second step of distributing remaining messages remaining in queues used by active system node apparatuses contained in the list of other active system node apparatuses to the queue used by the added active system node apparatus.

6. A message distribution method according to claim 5, wherein:
the standby system node apparatus acquires the numbers of remaining messages by referring to queues used by active system node apparatuses contained in the list of other active system node apparatuses after execution of the first step; and
the standby system node apparatus distributes the remaining messages at the second step so that the numbers of remaining messages in queues used by active system node apparatuses contained in the list of other active system node apparatuses and the number of remaining messages in the queue used by the added active system node apparatus after distribution of the messages are averaged on the basis of the acquired numbers of remaining messages.

7. A standby system node apparatus in a clustered computer system including:
active system node apparatuses for storing accepted messages in queues respectively and executing a user program on the basis of the accepted messages;
the standby system node apparatus; and
a storage device for storing queues used by the active system node apparatuses respectively, the storage device being formed so that the active system node apparatuses and the standby system node apparatus can make access to the storage device;
wherein when the standby system node apparatus recognizes occurrence of a fault in any one of the active system node apparatuses, the standby system node apparatus distributes remaining messages remaining in a queue used by the fault active system node apparatus to a queue used by another active system node apparatus where no fault occurs.

8. A standby system node apparatus in a clustered computer system including:
active system node apparatuses for storing accepted messages in queues respectively and executing a user program on the basis of the accepted messages;
the standby system node apparatus; and
a storage device for storing queue-node correspondence information indicating correspondence between a queue used by each of the active system node apparatuses and a node apparatus using the queue, the storage device being formed so that the active system node apparatuses and the standby system node apparatus can make access to the storage device;
wherein when the standby system node apparatus recognizes occurrence of a fault in any one of the active system node apparatuses, the standby system node apparatus executes:
a first step of acquiring a list of other active system node apparatuses using queues having the same name as a queue used by one of the active system node apparatuses by referring to the queue-node correspondence information stored in the storage device; and
a second step of distributing remaining messages remaining in the queue used by one active system node apparatus to queues used by active system node apparatuses contained in the list of other active system node apparatuses.

9. A standby system node apparatus according to claim 8, wherein:
the standby system node apparatus acquires the numbers of remaining messages by referring to queues used by active system node apparatuses contained in the list of other active system node apparatuses after execution of the first step; and
the standby system node apparatus distributes the remaining messages at the second step so that the numbers of remaining messages in queues used by active system node apparatuses contained in the list of other active system node apparatuses are averaged on the basis of the acquired numbers of remaining messages.

10. A standby system node apparatus according to claim 8, wherein:
the standby system node apparatus acquires queue sequence information stored in the storage device and indicating a message processing sequence after execution of the first step; and
the standby system node apparatus distributes the remaining messages to a queue used by one of active system node apparatuses contained in the list of other active system node apparatuses in a sequence based on the acquired queue sequence information at the second step.

11. A standby system node apparatus in a clustered computer system including:
active system node apparatuses for storing accepted messages in queues respectively and executing a user program on the basis of the accepted messages;
the standby system node apparatus; and
a storage device for storing queue-node correspondence information indicating correspondence between a queue used by each of the active system node apparatuses and a node apparatus using the queue, the storage device being formed so that the active system node apparatuses and the standby system node apparatus can make access to the storage device;
wherein when the standby system node apparatus receives a message distribution request from an active system node apparatus added to the message queuing system, the standby system node apparatus executes:
a first step of acquiring a list of other active system node apparatuses using queues having the same name as a queue used by the added active system node apparatus by referring to the queue-node correspondence information stored in the storage device; and
a second step of distributing remaining messages remaining in queues used by active system node apparatuses contained in the list of other active system node apparatuses to the queue used by the added active system node apparatus.

12. A standby system node apparatus according to claim 11, wherein:
the standby system node apparatus acquires the numbers of remaining messages by referring to queues used by active system node apparatuses contained in the list of other active system node apparatuses after execution of the first step; and
the standby system node apparatus distributes the remaining messages at the second step so that the numbers of remaining messages in queues used by active system node apparatuses contained in the list of other active system node apparatuses and the number of remaining messages in the queue used by the added active system node apparatus after distribution of the messages are averaged on the basis of the acquired numbers of remaining messages.

13. A program readable on a computer including active node apparatus, a standby system node apparatus, and a storage device thereby to execute a message distribution comprising:
a first step of acquiring a list of other active system node apparatuses using queues having the same name as a queue used by one of the active system node apparatuses by referring to the queue-node correspondence information stored in the storage device; and
a second step of distributing remaining messages remaining in the queue used by one active system node apparatus to queues used by active system node apparatuses contained in the list of other active system node apparatuses.
